(19) United States
(12) Patent Application Publication
(10) Pub. No.: US 2015/0360649 A1
(43) Pub. Date: Dec. 17, 2015

(54) Windshield clearing and cleaning apparatus for motor vehicles with performance improving applications

(71) Applicant: RICHARD DEAN NEFF, Springville, NY (US)

(72) Inventor: RICHARD DEAN NEFF, Springville, NY (US)

(21) Appl. No.: 14/120,675

(22) Filed: Jun. 16, 2014

(51) Int. Cl. B60S 1/38; B60S 1/48; B60S 1/54; B60S 1/52

(52) U.S. Cl. CPC B60S 1/38; B60S 1/524; B60S 1/488; B60S 1/546; B60S 2001/3827; B60S 2001/3839; B60S 2001/3836

(57) ABSTRACT

The Windshield Clearing and Cleaning Apparatus for Motor Vehicles with Performance Improving Adaptations is a revolutionary new design for windshield wiper blades incorporating several possible embodiments in which the accumulation of rain water or snow which makes the use of windshield wipers necessary is removed from the windshield in a new and much more efficient manner due to either the wider and firmer construction of the V-Blade which makes the pushing action of the blade result in more complete removal, or the throwing action caused by the unique shaping of the C-Blade which removes the rain or snow from the windshield completely, rather than just pushing it aside. Another related embodiment is not actually a blade at all, but a single tube or a plurality of tubes which remove the rain or snow by means of high pressure air or high pressure water, removing it from the windshield entirely, much as is done by the aforementioned C-Blade. The V-Blade and C-Blade embodiments could be manufactured of a variety of materials, including but not limited to a transparent silicone material, rubber, or flexible plastic. The housing could also be manufactured of a variety of materials, including transparent polycarbonate material, metal, or hard plastic. The tubes in the alternative embodiment could be made of clear plastic surgical tubing or any other form of flexible tubing which would give the necessary strength and durability. Materials used to manufacture any of these components could be anything which will meet the specifications which will allow the unit to perform the functions for which it is designed in a complete and correct manner. The designs of these wipers are also serve to make cleaning of a soiled or greasy windshield easier and more effective, in a shorter period of time. Also disclosed is a modified wiper blade housing, which is specifically adapted to the unique design of the V-Blade and C-Blade which would be manufactured and sold in conjunction with these blades. This blade housing would be adaptable for use with wiper support arms currently in use.

### BACKGROUND OF THE INVENTION

The Windshield Clearing and Cleaning Apparatus for Motor Vehicles, with Performance Improving Adaptations is a revolutionary new design for windshield wiper blades, incorporating special design features to improve performance and durability of said blade, plus the possible use of a differently configured manufacturing material for said blade which makes the unit less distracting while in use, and therefore safer for the user. The preferred embodiment of said wiper blade, called the C-blade, has a unique design, incorporating mirror image “C” shapes reminiscent of back to back snowplow blades in which the two reverse facing tips remove rain and snow from said windshield and throw it to the side in much the same manner in which a snowplow blade removes snow from a road. This is in contrast to blades currently in use which simply push the water or snow ahead of said blade, leaving a puddle of water or a pile of snow at the end of each pass, to be pushed back in the other direction by the next pass of said blade, if at the inner end of the pass, or simply remain there if at the outer end. Another offered embodiment shows the V-blade, which is somewhat similar in shape to conventional blades, but much thicker, resembling a squeegee, so that the edge of said blade will remain in contact with said windshield at all times, rather than flipping over between each pass as do blades currently in use, allowing for more complete clearing of said windshield. Both said C-blade and said V-blade are much thicker at the upper edge where said blade fits into the specially adapted blade holder, described in U.S. Provisional Patent Document 61/956,606, Neff, Richard D. Jun. 13, 2013, to which this document refers, making that portion of said wiper blade much stronger, to resist the breaking and tearing which is often a cause of failure in said conventional blades. The increased thickness of the blade itself also resists wear and tear, noticeably increasing blade life. Two other possible embodiments of said V-blade are illustrated in this document. One is the Channel blade which has an opening through the middle of the blade below the attaching area to dispense either high pressure water or high pressure air onto said windshield. The second is a new adaptation of a dual blade wiper, wherein both blades are molded in one piece rather than being two totally separate blades fastened together into one holder. This would make said double blade wiper stronger and more durable than double bladed wipers currently in use.

The document illustrates another embodiment that isn't really a blade at all, but a tube or system of tubes that does not scrape said windshield like a regular blade, but instead channels a spray of high pressure warm or cool air or high pressure warm or cool water onto said windshield to quickly remove rain, snow, ice, or dirt from said windshield by blowing or washing it away from said windshield and forcing it off the side of said vehicle.

Said wiper blade holder has been adapted to hold said newly designed wiper blades securely, and includes support brackets so that the edge of said blade can be held more firmly in contact with said windshield during passes in both directions, and pins to hold said blade more firmly in said holder.

### REFERENCES CITED

UNITED STATES patent DOCUMENTS

| | | | |
|---|---|---|---|
| 1. 4,060,872 | Bucklitzsch, Hans H. | 15/250.041 | Dec. 6, 1977 |
| 2. 4,745,653 | Bliznak, Bedrich V. | 15/250.4 | May 24, 1988 |
| 3. 5,383,247 | Nickel, Klaus D. | 15/250.04 | Jan. 24, 1995 |
| 4. 7,150,795B2 | Javaruski, Russell | 134/6 | Dec. 19, 2006 |
| | J. et al | | |
| 5. 2008/0034527A1 | George, Dillon D. | 15,250.001 | Feb. 14, 2008 |
| 6. 8,069,527B2 | Harita, Yasuhiro | 15/250.04 | Dec. 6, 2011 |

UNITED STATES PROVISIONAL patent DOCUMENTS

| | | |
|---|---|---|
| 1. 61/956,606 | Neff, Richard D. | Jun. 12, 2013 |

### BRIEF DESCRIPTION OF THE PRIOR ART

In U.S. Pat. No. 4,060,872, Bucklitzsch discloses a wiper blade which dispenses water or windshield washer fluid onto a windshield through channels in the blade. In the disclosed embodiments the blade is large and cumbersome, which would interfere with driver visibility while the blade is in use. The currently disclosed invention achieves the same results by using a narrower blade, with the channel placed completely within the blade rather than extending above the upper surface of the blade, or suspended from the bottom of the upper housing strip, both of which reduce strength and stability. The currently disclosed invention also incorporates two other features which Buclitzsch does not offer. Bucklitzsch does not disclose any method for the fluid used in his system to be heated, which would assist in removing dirt and oily road film from the windshield. Bucklitzsch also does not disclose a means for switching the system from the distribution of high pressure water to high pressure air, either cool or heated, which would help to dry a wet windshield, either from rain or from the cleaning process, or to melt or blow away snow which has accumulated on the windshield. Also, the channel illustrated in the channel blade is not a complete circle, but has a slightly upraised indentation on the bottom, which makes it stronger and channels the fluid more completely and evenly onto the windshield to insure better clearing and cleaning action.

In U.S. Pat. No. 4,745,653 Bliznak discloses a wiper blade consisting of three wiper blades arranged in a three pointed star type formation pointing outward from a central support structure, with each blade incorporating an assortment of scrubbing and scraping surfaces each designed for different conditions, In order for different blade surfaces to be in contact with the windshield, the blade assembly must be manually turned to bring the desired sections into position. Bliznak also discloses a porous pad positioned between two blade sections to wipe windshield washer fluid onto the windshield. The amount of fluid deposited on the windshield by this device would be limited, and there would be no pressure behind the fluid to loosen dirt or packed snow and ice from the windshield. There is also the problem that the porous pad would be subjected to a large amount of stress from being scraped back and forth over the windshield which would result in the pad being torn or simply wearing out quickly. The currently disclosed invention includes various embodiments which deposit high pressure water or windshield washer cleaning fluid on the windshield, which assists in loosening dirt from the windshield and allowing it to be wiped away by the action of the blade, without added scraping action, either done manually or requiring a special wiper blade apparatus such as Bliznak discloses, and without the position of the blade needing to be manually adjusted The currently disclosed invention also incorporates a means for heating the water or fluid before it is deposited on the windshield, which will not only assist in removing dirt, but also aid in removing snow and/or ice which have accumulated on the windshield due to inclement weather, without need for manual scraping. The currently disclosed invention also incorporates a means for changing the flow onto the windshield from cool or heated fluid to cool or heated air, which would assist in drying the windshield after cleaning, and in blowing accumulated snow off the windshield without scraping, either manually or with a special blade.

In U.S. Pat. No. 7,150,795B2, Javaruski discloses a windshield wiper blade and arm assembly fabricated from transparent material. The basic design is no different from those currently in use on motor vehicles, so no improvement in the efficiency of the blade is projected. He also discloses addition of a polychromatic dye which causes the blade and wiper arm assembly to turn black when exposed to light, thus negating the improvement of driver visibility which might be attained by using transparent material to fabricate the blade and wiper arm. The currently disclosed invention incorporates new and unique designs for the wiper blade itself, which greatly improve the effectiveness of the blade when removing rain or snow from the windshield, or when cleaning off dirt, insect residue, or oily road film. The currently disclosed invention may also be fabricated of transparent material if desired, but by using materials which do not cause glare, such as but not limited to nylon or teflon, polychromatic dye would not be required, therefore allowing the improvement in driver visibility to be retained. The blade could also be fabricated of plastic or hard rubber as blades currently in use are, since the material from which the blade is fabricated does not affect the added efficiency of the newly designed blades.

In US2008/0034527A1, George also discloses a wiper blade and arm assembly fabricated of transparent material, but does not disclose a new or more efficient design of blade. The currently disclosed invention incorporates new and unique designs for a windshield wiper blade, which could be fabricated of transparent materials if desired, but the material used in such fabrication does not affect the efficiency of the blade when in use. The newly designed blade embodiments will greatly improve the effectiveness of the blade when engaged in the process of removing rain or snow from the windshield or when cleaning off dirt, insect residue, or oily road film.

In U.S. Pat. No. 8,069,527B2, Harita discloses a windshield wiper blade incorporating a plurality of fluid dispensing openings dispersed within the central section of the wiper blade holder, to spray windshield washing fluid or water onto the windshield. By being located only in the central portion of the wiper blade holder, the windshield washing fluid would need to be sprayed at an angle, rather than straight down, in order to reach all sections of the windshield. This would not allow the fluid to be under pressure when it reaches the windshield which would make the cleaning action of the fluid less effective. It would also cause the spray to be spread out over a wide area, causing the amount of fluid reaching a specific area of the windshield to be less concentrated, reducing the amount of cleaning action possible. The currently disclosed invention shows a means for windshield cleaning fluid or water to be dispensed onto the windshield at high pressure along the entire length of the blade, through the blade itself rather than being limited to the central area of the blade holder, insuring a more even distribution of cleaning fluid, with the pressurized fluid applied to the windshield creating a more effective cleaning process. The currently disclosed invention also incorporates a means for heating the windshield washing fluid or water, since warm fluid is a more effective cleaning agent than cold fluid.

### PARTS LIST

1. V-Blade
2. Blade Housing
   2A. Adapted Blade Housing
   2B. Connection Indentation
3. Upsweep C-Blade
   3A. C-Curve Side
   3B. Raised Area
4. Water/Air Conducting Tube
5. Water/Air Dispensing Opening
6. Water/Air Conducting Tube Cap
7. Downsweep C-Blade
8. Connecting Shaft
9. Securing Bar
10. Blade Holder to Wiper Arm Connecting Means
11. Wiper Blade Holder Connection Area
12. Water/Air Conducting Tube Cap Locking Pins
13. Water/Air Intake
14. Tube Brace Rod
15. Tube Clamps
16. Tube Support Wheel
17. Support Wheel Connecting Rod
18. Water Storage Tank
19. Water Fill Area
20. Two Chamber Water/Air Heating Unit
21. Air Intake
22. Water Storage Tank to Heater Transfer Tube
23. Warm Air Transfer Tube
24. Warm Water Transfer Tube
25. Electric Compressor Pump
26. High Pressure Water/Air Feed Tube
27. Valve Control Shutoff
28. Control Unit
29. Wiper Blade Locking Pins
30. Channel Blade
   30A. Water/Air Conducting Channel
31. Divided Blade
32. Support Structure
33. Support Structure Connecting Pin
34. Support Structure Connecting Clips
   34A. Adapted Blade Holder
35. Blade Holder
36. Inserting Space
37. Attaching Means
38. Pressure Clip Holder
39. Securing Protrusion
40. Pressure Clip Indentation
41. Pressure Clip
42. Support Walls
43. Securing Rod
44. Pressure Clip Sliding Opening
45. Bottom pressure Clip Panel
46. Locking Means
47. Locking Projections
48. Attaching Means Stopper
49. Lock Release
50. Connector Housing
51. Side Walls
52. Flat Metal Rod
53. Central Space
54. Connecting Protrusions
   54A. Attaching Protrusions
55. Groove Holder
56. Blade Stopper Wall
57. Blade Holder Pin
58. Windshield
59. Wiper Arm Clips

### BRIEF DESCRIPTION OF THE DRAWINGS

The described drawings illustrate preferred embodiments of the invention and are therefore not to be considered limiting of its scope, for the invention may admit to other equally effective equivalent embodiments.

FIG. 1 Illustrates a cross section view of the V-Blade, attached inside the specially designed blade housing. A wiper blade housing connector is also shown.

FIG. 2 illustrates a cross section view of the upsweep C-Blade, attached inside an adapted blade housing. Said wiper blade housing connector is also shown.

FIG. 3 illustrates a cross section view of an alternative embodiment of said V-Blade, in which a water/air conducting tube with water/air dispensing openings is positioned on one side of said V-Blade Said V-Blade is attached inside said blade housing, and said wiper blade housing connector is also shown.

FIG. 4 illustrates a cross section view of an alternative version of the embodiment shown in FIG. 3, with said water/air conducting tubes located on both sides of said V-Blade, with said water/air dispensing openings on each of said water/air conducting tubes. Said V-Blade is attached inside said blade housing, and said wiper blade housing connector is also shown.

FIG. 5 illustrates a cross section view of the downsweep C-Blade, attached inside said blade housing. Said blade housing is also shown.

FIG. 6 illustrates an alternative embodiment of a Windshield Clearing and Cleaning Apparatus which consists of a single water/air conducting tube or a plurality of such tubes connected to a tube brace rod by tube clamps Said water/air conducting tubes transport high pressure water or high pressure air to said windshield to remove rain or snow, or to facilitate cleaning of a dirty windshield. Water/air intakes are at the lower extremity of said tube/tubes to send said high pressure air or high pressure water along the full length of said tube/tubes.

FIG. 7 illustrates an alternative view of the embodiment shown in FIG. 6, with said water/air intakes located in the center of said water/air conducting tube/tubes, to send said high pressure air or high pressure water to both ends of said water/air conducting tube/tubes, and onto said windshield.

FIG. 8 illustrates an open ended view of said plurality of water/air conducting tubes, with said water/air dispensing openings directed toward various areas of said windshield, to assure even distribution of said high pressure water or high pressure air.

FIG. 9 illustrates an open end view of a single water/air conducting tube unit with a plurality of said water/air dispensing openings directed toward different areas of said windshield to assure even distribution of said high pressure water or high pressure air.

FIG. 10 illustrates a portion of said water/air conducting tube, including a water/air conducting tube cap which is connected to a rubber or plastic tube support wheel which is slightly larger in diameter than said water/air conducting tube cap by a short metal or plastic support wheel connecting rod. Said tube support wheel holds said water/air conducting tube elevated slightly from said windshield preventing direct contact between said water/air conducting tube and said windshield to prevent interference with the passage of said high pressure water or high pressure air in the performance of its function.

FIG. 11 illustrates an isolated close-up view of said water/air conducting tube cap incorporating said tube support wheel.

FIG. 12 illustrates the complete water/air conducting tube assembly.

FIG. 13A is an illustration of the heating and compression system which is located beneath the hood of a vehicle using the warm pressurized water/warm pressurized air system.

FIG. 13B illustrates the control unit for the heating and compression system shown in FIG. 13A, which would most likely be located inside a vehicle using the warm pressurized water/warm pressurized air system, probably but not necessarily on the dashboard of said vehicle.

FIG. 14 illustrates an end view of a possible adaptation for said blade housing to hold said V-blade embodiments and said C-blade embodiments, with said V-blade shown held inside said blade housing by one of a plurality of wiper blade locking pins.

FIG. 15 illustrates an end view of said blade housing as it would appear without said V-blade, said upsweep C-blade or said downsweep C-blade being held inside it.

FIG. 15A illustrates an end view of said adapted blade housing as it would appear without said V-blade, said upsweep C-blade or said downsweep C-blade being held inside it.

FIG. 16 illustrates an end view of said V-blade separate from said blade housing, allowing the specially adapted connecting shaft and securing bar of said blade to be clearly seen.

FIG. 17 illustrates an adaptation of said V-blade incorporating a wiper blade channel through the center of said blade with said water/air dispensing openings shown on both sides of said channel blade to dispense said high pressure water or high pressure air onto said windshield from said blade itself, rather than using said water/air conducting tubes.

FIG. 18 illustrates another possible adaptation of said V-blade incorporating a divided blade molded as a single unit with a shared connecting shaft and securing bar for added strength and durability.

FIG. 19 illustrates a newly designed wiper blade holder for said V-blade embodiments, and said upsweep C-blade and said downsweep C-blade embodiments, which incorporates support structures which connect to said wiper blade holder to insure more complete and constant contact between said blade and said windshield. The drawing shows said V-blade secured within said blade housing which is attached to said wiper blade holder. A wiper blade holder connection opening is also shown,

FIG. 20 illustrates an end view of a blade holder to wiper arm connecting means for connecting said wiper blade holder to the wiper arm which is attached to said vehicle Said blade housing to wiper arm connecting means is molded into said blade housing. Said blade holder to wiper arm connecting means is compatible with wiper arms currently in use, allowing the blade embodiments of the currently disclosed invention to be used with said wiper arms.

FIG. 21 illustrates an exploded side view of said wiper blade holder to wiper arm connecting means. The body of said wiper blade holder to wiper arm connecting means incorporates an inserting space to receive the connecting clip of said wiper support arm connected to said vehicle. A pressure clip is shown in a separate view, with the location of said pressure clip within the body of said wiper blade holder to wiper arm connecting means indicated by dotted lines. A slot for connection of said wiper blade holder to wiper arm connecting means is also indicated by dotted lines.

FIG. 22 illustrates a down view of said blade holder to wiper arm connecting means, showing said inserting space and said pressure clip.

FIG. 23 illustrates an underneath view of said blade housing to wiper arm connecting means, showing the underside of the end of said pressure clip extending from the inner end of said blade holder to wiper arm connecting means.

FIG. 24 illustrates an underneath view of an attaching means incorporated into said blade holder to wiper arm connecting means. A lock release is shown to release the locking means. Attaching means stoppers are also shown.

FIG. 25 illustrates a side view from inside said attaching means. A lock release is shown to release said blade holder to wiper arm connecting means from said blade holder when said blade needs to be replaced. Said attaching means stopper is also shown.

FIG. 26 illustrates a view looking down at the upper side of a connector housing which secures said blade holder to wiper arm connecting means to said blade holder.

FIG. 27 illustrates a view looking upward at the underside at the underside of said connector housing. An optional flat metal rod which is bent slightly at its center is shown by dotted lines, positioned between the side walls, resting upon the inside bottom surface of a central opening in the upper side of said blade holder, intended to keep said blade holder in a slightly curved position to hold said blade securely against said windshield.

FIG. 28 illustrates a down view of said blade housing showing said central opening into which is molded said connector housing to which said blade holder to wiper arm connecting means is attached. Connecting protrusions are shown, as is said flat metal rod, bent into a slight curve at the center, which is which is inserted into a slot between said blade holder and said connector housing.

FIG. 29 illustrates an upward looking view from beneath said blade housing. Said flat metal rod is shown resting inside an optional groove holder designed to hold said flat metal rod securely in place. A blade stopper wall is also shown, as is a blade holding pin to keep said blade from coming out of said blade housing.

FIG. 30 illustrates a side view of said blade housing without a blade inserted within it. The presence of said connector housing, molded into said blade housing, is indicated by said connecting protrusions which are visible on the upper edge of said blade housing.

FIG. 31 illustrates a side view of said blade holder with a blade inserted within it. The presence of said connector housing, molded within said blade holder, is indicated by said connecting protrusions which are visible on the upper edge of said blade holder.

Referring to the drawings herein, like reference characters designate like or corresponding parts throughout the several views. The described drawings illustrate a preferred embodiment of the invention and are therefore not to be considered limiting of its scope, for the invention may admit to other equally effective equivalent embodiments.

### DESCRIPTION OF TILE PREFERRED EMBODIMENT

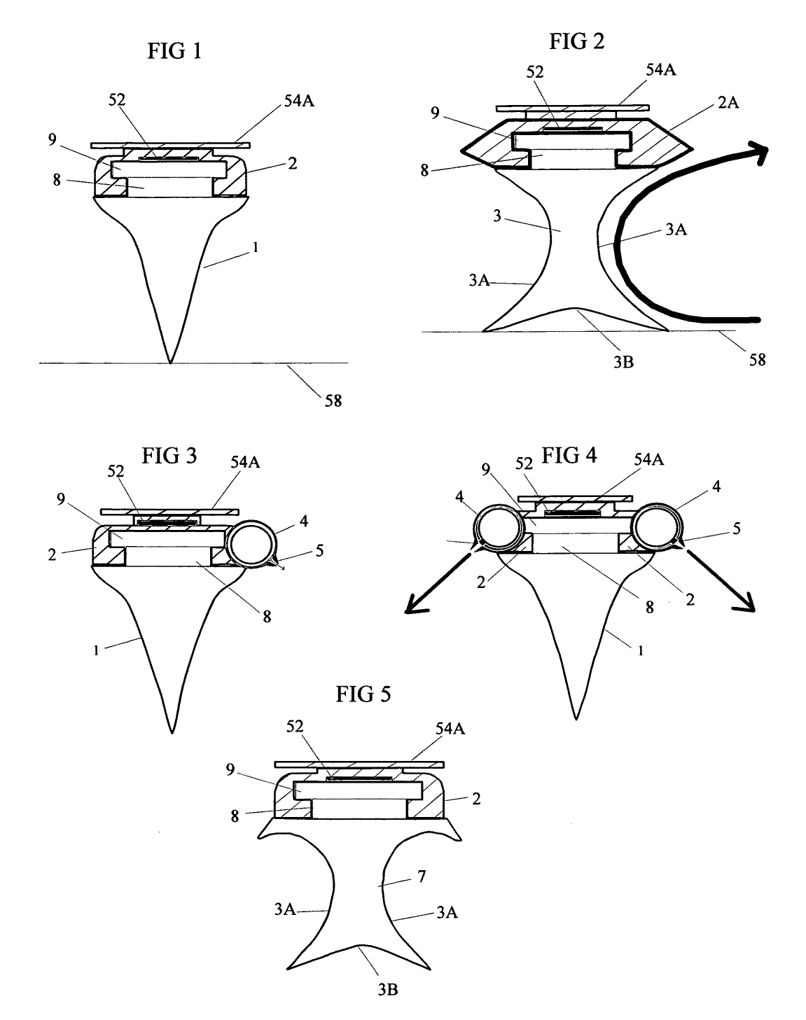

FIG. 1 illustrates a cross section view of the V-blade 1, a wiper blade for clearing water or snow and cleaning dirt, mud, or insect residue from the windshield 58 of a motor vehicle. The adapted blade design is constructed to allow said V-blade 1 to work more efficiently, while at the same time decreasing wear and increasing blade longevity. The “V” shape of said V-blade 1 is thicker than a conventional blade, allowing it to have a squeegee action against said windshield 58. Said squeegee action of said thicker V-blade 1 is more efficient at removing water or snow than the thin tip of conventional blades, which tend to curl when changing from forward to backward cleaning strokes and sometimes even lose contact with said windshield 58 at the end points of said cleaning strokes, since said conventional blades basically have to flip over between the forward and return strokes of said conventional blade. This squeegee action of said V-blade 1 is also more effective for the cleaning process than said conventional blade, since this action allows water or windshield cleaning fluid to be dispersed over said windshield 58 more evenly; and the thicker, firmer V-blade 1 provides better cleaning action since it maintains more complete and more constant contact with said windshield 58. It also allows used water or windshield cleaning fluid, and the dirt it contains, to be removed from said windshield 58 more quickly and completely than it would be by said conventional blade, rather than allowing the liquid and dirt to remain on said windshield 58 to interfere with driver vision, requiring a second cleaning process to be initiated. The thicker shape of said V-blade 1 also resists wear caused by the constant back and forth motion of said wiper blade while in use, much more effectively than the thinner, pointed shapes which typify said conventional wiper blades. A specific thickness of said V-blade 1 is not required. Any thickness which is greater than that of said conventional blades and would perform the functions for which said V-blade 1 is designed would be acceptable, and therefore would not violate the spirit and scope of the invention.

Also illustrated in this drawing are connecting shaft 8, and securing bar 9, which fit into blade housing 2, shown in this illustration as an end view into which said V-blade 1 is inserted when prepared to be attached to the wiper system of said motor vehicle. Said attaching protrusions incorporated in said connection housing incorporated in said adapted blade holder 35A are shown. Optional flat metal rod 52 is shown in the position in which it would be located within said blade holder to wiper arm connecting means 10 In the current embodiments said wiper blade housing connecting means 10 would be compatible with wiper blade support arms currently in use. In future embodiments said blade holder to wiper arm connecting means 10 could be adapted to the design illustrated in FIG. 19, to work with a newly designed wiper blade support arm created specifically for use with the currently disclosed blades, without changing the basic function of the currently disclosed blades. Said connecting shaft 8 and said securing bar 9 are molded to be considerably thicker than corresponding parts on said conventional wiper blades, making the unit much less likely to tear at the point of insertion into said blade housing 2. Said blade housing 2 is specially constructed to receive said V-blade 1 embodiments, holding it securely, but allowing sufficient flexibility to prevent said V-blade 1 from being torn from said connecting shaft 8 or said securing bar 9 by the stress of repeated shifts in the direction of said cleaning strokes. Conventional blades are also subject to tearing at the point of connection to said housing because of the thinness of said shaft, should said blade become frozen to said windshield 58, and power be applied to said wiper system without first freeing said blade from said windshield 58.

Said V-blade 1 and said blade housing 2 could be constructed of a transparent silicone base material, which would interfere with operator visibility in a very limited way, if at all. Said V-blade 1 and said blade housing 2 could also be made of rubber, and said blade holder 35 could be made of transparent polycarbonate material, metal, or hard plastic as units currently in use are, but following the design parameters described herein, to retain the added effectiveness of performance. The material used would not alter the spirit and scope of the invention.

FIG. 2 illustrates a cross section view of the upsweep C-blade 3, another embodiment of a wiper blade for clearing water or snow and cleaning dirt, mud, or insect residue from the windshield 58 of a motor vehicle, which is designed to allow said blade to work more efficiently, while at the same time decreasing wear and increasing blade longevity. Said upsweep C-blade 3 is configured with two opposing C-curve sides 3A, each in the shape of a “C”, the outermost edges of which fit flush against said windshield 58 when in use. Each of these said C-curve sides 3A is similar in shape to a snowplow blade, with a slightly raised area 3B on the bottom of said upsweep C-blade 3 between the lower ends of the two said opposing C-curve sides 3A. The inclusion of said raised area 3B exerts pressure on the lower points of both said C-curve sides 3A, insuring that they will come into and remain in constant contact with said windshield 58, without having to flip over between forward and return strokes as said conventional blades do. Said opposing C-curve sides 3A of said upsweep C-blade 3 face in opposite directions, allowing one said C-curve side 3A to move water or snow off said windshield 58 on the forward stroke, and the other said C-curve side 3A to repeat this action on the return stroke. With said conventional blade, water or snow is simply pushed to one side by the stroke of the blade and left to collect either in the center of said windshield 58, or along the outer edge of said windshield 58. With said upsweep C-blade 3, the curvature allows water or snow to be pushed up by the lower edge of said C-curve side, guided away from the wiping area by said upsweep C-blade 3, following the direction indicated by the arrow in the drawing, pushed away from the central area of said windshield 58 and for the most part thrown completely off of said windshield 58, rather than being left lying in the middle of, or on the side of said windshield 58, where it can be blown back into the line of vision of the driver, and have to be removed again by repeated use of the wiper system. Since this throwing action occurs on both the forward and return strokes of the upsweep C-blade 3, said windshield 58 is cleared much faster and more effectively than with conventional blades. This also makes the use of cleaning fluid more effective, since more constant contact allows the solution to be dispersed more evenly, the firmness of the upsweep C-blade 3 edge provides better cleaning action, and the throwing action caused by the shape of said upsweep C-blade 3 blade allows water or windshield cleaning fluid and dirt to be removed from said windshield 58 quickly and completely rather than remaining on said windshield 58 to further interfere with the vision of the driver. FIG. 2 also illustrates adapted blade housing 2A, which is shaped to assist said upsweep C-blade 3 in removal of rain, snow, and dirty windshield cleaning fluid from said windshield 58. This adapted shape does not alter the basic function of said blade housing 2. Therefore it does not fall outside the spirit and scope of the invention. Said upsweep C-blade could also use said blade housing 2 if desired.

The central area of said upsweep C-blade 3, between the two said “C” curve sides 3A is thick, to provide support to said “C” curve sides 3A on both the forward and return strokes. Said connecting shaft 8 and said securing bar 9 of the unit, which connect said upsweep C-blade 3 to said adapted blade housing 2A are also much thicker than in conventional wiper blades. The thin shafts which are used to connect said blade to said housing in conventional systems, are much more prone to fail under the wear and tear of normal use than the thicker construction of the currently disclosed embodiment. Said conventional blades are also subject to tearing at the point of connection to said housing because of the thinness of said shaft, should said blade become frozen to said windshield 58, and power be applied to said wiper system without first freeing said blade from said windshield 58. Said thicker connecting shaft 8 and said securing bar 9 incorporated in this embodiment of said upsweep C-blade 3 provide added strength and will be more resistant to tearing should said system inadvertently be turned on without said upsweep C-blade 3 being freed from its frozen condition. Said attaching protrusions incorporated in said connection housing incorporated in said adapted blade holder 35A are shown. Said optional flat metal rod 52 is shown in the position in which it would be located within said blade holder to wiper arm connecting means 10. In current embodiments said blade holder to wiper arm connecting means 10 would be compatible with wiper blade support arms currently in use. In future embodiments said wiper blade housing connector 10 could be adapted to the design illustrated in FIG. 19, to work with a newly designed wiper blade support arm created specifically for use with the currently disclosed blades, without changing the basic function of the currently disclosed blades.

Said upsweep C-blade 3, said blade housing 2 and said adapted blade housing 2A could be constructed of a transparent silicone base material, which would interfere with driver visibility in a very minor way, if at all, or said upsweep C-blade 3, said blade housing 2 and said adapted blade housing 2A could be made of rubber as blades currently in use are, but using the unique design parameters of said currently disclosed upsweep C-blade 3 and blade housing 2 or adapted blade housing 2A. Said blade holder 35 could be made of transparent polycarbonate material, metal, or hard plastic, also using the design parameters of said blade holder 35 This adaptation would follow said design parameters described herein, in order to retain the added effectiveness of performance of the unit, so therefore the material used would not alter the scope and spirit of the disclosed invention.

This view illustrates said upsweep C-blade 3 inserted within an adapted blade housing 2A. This adapted blade housing 2A is designed to increase the length of said C-curve sides 3A by extending the curvature of said C-curve sides 3A beyond the upper extremity of said C-blade 3. This will enable said water, snow, and/or windshield cleaning solution to be thrown in the direction indicated by the arrow in the drawing, thereby increasing the distance that said water, snow, and/or windshield cleaning solution will be thrown, making it more probable that it will be thrown off said windshield 58 completely.

FIG. 3 illustrates a cross section view of an alternate embodiment of said V-blade 1 which incorporates an adaptation consisting of a water/air conducting tube 4 located on one side of said V-blade 1, at the upper extremity of said V-blade 1, in the area beside where said V-blade 1 connects to said blade housing 2. In this embodiment, said blade housing 2 is indented slightly on the side where said water/air conducting tube 4 is located, to allow said water/air conducting tube 4 to be attached with tube clamps 15, which are not visible in this illustration. Said water/air conducting tube 4, which could be constructed using molded transparent plastic or clear, flexible surgical tubing, is connected to a to a small electric compressor pump 25, most probably located under the hood of said vehicle. Said electric compressor pump 25 then channels said high pressure air into said water/air conducting tube 4. Said water/air conducting tube 4 incorporates a plurality of small water/air dispensing openings 5 which could be round holes or thin slots, located on the underside of said water/air conducting tube 4, along the full length of said water/air conducting tube 4, which direct said high pressure air flow onto said windshield 58, at an angle slightly ahead of the forward edge of said V-blade 1. The purpose of said high pressure air flow is to blow said water or snow which is collected on said windshield 58 in a direction away from said V-blade 1, possibly blowing part or all of said water or snow completely off said windshield 58, causing there to be considerably less water or snow remaining on said windshield 58 after each forward or return stroke. The small portion which remains will be easily wiped away by both the forward and return strokes of said V-blade 1, leaving said windshield 58 clear and dry. In another adaptation of this embodiment, said water/air conducting tube 4 could be equipped with a “Y” connection, allowing an alternation between high pressure air flow and high pressure water flow to be channeled onto said windshield 58. Said high pressure water flow would be provided by a second electric compressor pump 25, also positioned under the hood of said vehicle. Switching between air and water is controlled by a control unit 28 as shown in FIG. 13B, containing separate on/off mechanisms, such as switches or buttons, for each function being controlled. Said control unit 28 would most probably be located on the dashboard of said motor vehicle. In this case, said control unit 28 would close off one section of said “Y” connection, and allow the other side to open, allowing the flow to change from air to water or from water to air. After the change has been made from air to water, high pressure water would be deposited on said windshield 58 through said water/air dispensing openings 5 in said water/air conducting tube 4, allowing said water to be dispersed more evenly upon said windshield 58 than with the spray devices currently in use. The pressure with which said water is applied serves to loosen dirt, mud, insect residue, or oily road film from the glass, and allow it to be wiped away by said forward and return strokes of said V-blade 1 before it can settle back onto said windshield 58. Instead of water, windshield cleaning fluid could be used in this adaptation to provide a more complete cleaning action, with a two chamber water/air heating unit 20 incorporated into the system as illustrated in FIG. 13A, also under the hood of the vehicle, to warm said water or windshield cleaning fluid before it is deposited on said windshield 58. The purpose of heating said water or fluid is dual in nature. First, warm fluid is more effective in removing dirt, especially oily film, from windshield glass. Second, said warm fluid would be more effective at melting any ice coating which might have accumulated on said windshield 58 due to cold temperatures or winter storms. This warm fluid would also serve to help free a wiper blade which has become frozen to said windshield 58, before wiping action commences. When said ice has been melted by said warm fluid, said melted ice and snow would be easily removed by the normal wiping action of said wiper blade, possibly combined with warm high pressure air now channeled through the same water/air conducting tubes 4 that dispensed the cool or heated fluid, without the need for prior scraping of said windshield 58. A thermostat would need to be incorporated as part of said two chamber water/air heating unit 20, to regulate the temperature of said heated water, windshield cleaning fluid, or air, to assure that it remains warm enough to melt said ice and loosen said dirt or oily film, but not become hot enough to crack a cold windshield 58. Power to operate said electric pumps 25, said heating unit 20 and said control unit 28 would be supplied from the battery of said vehicle.

As in the embodiment of said V-blade 1, illustrated in FIG. 1, said connecting shaft 8 and said securing bar 9 of the unit, which connects said V-blade 1 to said blade housing 2 is also much thicker than in conventional wiper blades. The thin shafts which are used to connect the blade to the housing in conventional systems, are much more prone to fail under the wear and tear of normal use than the thicker construction of the current embodiment. Conventional blades are also subject to tearing at the point of connection to a conventional housing because of the thinness of the shaft, should said conventional blade become frozen to said windshield 58, and power be applied without first freeing said conventional blade from said windshield 58. The thicker connecting shaft 8 and securing bar 9 incorporated in this embodiment of said V-blade 1 provides added strength and will be more resistant to tearing should the system inadvertently be turned on without said blade being freed from its frozen condition.

Said attaching protrusions incorporated in said connection housing incorporated in said adapted blade holder 35A are shown. Said optional flat metal rod 52 is shown in the location in which it would be located within said blade holder to wiper arm connecting means 10. In current embodiments said wiper blade housing connector 10 would be compatible with wiper blade support arms currently in use. In future embodiments said wiper blade housing connecting means 10 could be adapted to the design illustrated in FIG. 19, to work with a newly designed wiper blade support arm created specifically for use with the currently disclosed blades, without changing the basic function of the currently disclosed blades.

Said V-blade 1 and said blade housing 2 could be constructed of a transparent silicone base material, which would interfere with driver visibility in a very minor way, if at all, or it said V-blade 1 and said blade housing 2 could be made of rubber as blades currently in use are, but using the unique design parameters of the currently disclosed V-blade 1 and blade housing 2. Said blade holder 35 could be made of transparent polycarbonate material, metal, or hard plastic, also using the design parameters of said blade holder 35. This adaptation would follow the design parameters described herein, in order to retain the added effectiveness of performance of the unit, so therefore the material used would not alter the scope and spirit of the currently disclosed invention.

FIG. 4 illustrates a cross section view of an alternate embodiment of the V-blade 1 illustrated in FIG. 3, which incorporates said water/air conducting tubes 4 located on both sides of said V-blade 1, at the upper extremity of said V-blade 1, in the area where said V-blade 1 connects to said blade housing 2. For this embodiment said blade housing 2 is indented slightly on both sides to allow said water/air conducting tubes 4 to be attached with said tube clamps 15 which are not visible in this illustration. Said water/air conducting tubes 4, which could be constructed using molded transparent plastic or clear, flexible surgical tubing, are connected to said small electric compressor pump 25, equipped with said “Y” connection, allowing the flow of pressurized air to be divided between the two said water/air conducting tubes 4. Said electric compressor pump 25, which channels high pressure air into said air/water conducting tubes 4, would be located under the hood of said vehicle. Said water/air conducting tubes 4 incorporate a plurality of said small water/air dispensing openings 5 on the underside of each of said water/air conducting tubes 4, which direct said high pressure air flow onto said windshield 58, on both sides of said V-blade 1, at an angle slightly ahead of the forward edge of said V-blade 1, and slightly behind the rear edge of said V-blade 1, as indicated by the arrows in the drawing. Since said water/air conducting tubes 4 are positioned on both sides of said V-blade 1, this process would occur on both the forward and return strokes of said V-blade 1. The purpose of said high pressure air flow is to blow said water or snow collecting on said windshield 58 in a direction away from said V-blade 1, possibly blowing it completely off said windshield 58, causing there to be considerably less water or snow remaining on said windshield 58 after said forward or return stroke. The small portion which remains will be easily wiped away by both the forward and return strokes of said V-blade 1, leaving said windshield 58 clear and dry.

In another adaptation of this embodiment, said water/air conducting tubes 4 could each be equipped with a “Y” connection, allowing an alternation between high pressure air flow and high pressure water flow being channeled onto said windshield 58. Switching between air and water is controlled by said control unit 28 as shown in FIG. 13B, containing separate on/off mechanisms such as switches or buttons for each function being controlled. Said control unit 28 would most probably be located on the dashboard of said motor vehicle. In this case said control unit 28 would close off one section of said “Y” connection, and allow the other side to open, allowing the flow to change from air to water or from water to air. After the change has been made from air to water, high pressure water would be deposited on said windshield 58 through said water/air dispensing openings 5 in said water/air conducting tubes 4, allowing said water to be dispersed more evenly than with the spray devices commonly in use. The pressure with which said water is applied serves to loosen said dirt, mud, insect residue, or oily road film from the glass, and allow it to be wiped away by the forward and return strokes of said V-blade 1 before it can settle back onto said windshield 58. Instead of water, windshield cleaning fluid could be used in this adaptation to provide a more complete cleaning action, and said two chamber water/air heating unit 20 as shown in FIG. 13A could be added to the system, also possibly under the hood of the vehicle, to warm said fluid before it is deposited on said windshield 58. The purpose of heating said fluid is dual in nature. First, warm windshield cleaning fluid is more effective in removing dirt, especially oily film, from windshield glass. Second, warm fluid would be more effective at melting any ice coating which might have accumulated on said windshield 58 due to cold temperatures or winter storms. Said warm fluid, since in this embodiment it is being dispensed on both sides of said blade, would also serve to free a wiper blade which has become frozen to said windshield 58, before wiping action commences. When said ice has been melted by said warm fluid, said melted ice and snow would be easily removed by the normal wiping action of said V-blade 1, possibly combined with high pressure air now channeled through the same water/air conducting tubes 4 that dispensed said cool or heated fluid, without the need for prior scraping of said windshield 58. A thermostat would need to be incorporated as part of said two chamber water/air heating unit 20, to regulate the temperature of said heated fluid or air, assuring that it remained warm enough to loosen said accumulated dirt or melt said ice, but not become hot enough to crack a cold windshield 58.

As in the embodiment of the “V” blade illustrated in FIG. 1, the upper shaft of the V-blade 1, which connects the blade to the housing is also much thicker than in conventional wiper blades. The thin shafts which are used to connect the blade to the housing in conventional systems, are much more prone to fail under the wear and tear of normal use than the thicker construction of the current embodiment. Said conventional blades are also subject to tearing at the point of connection to the housing because of the thinness of the shaft, should said blade become frozen to said windshield, and power be applied without first freeing said blade from said windshield. The thicker shaft incorporated in this embodiment of said V-blade provides added strength and will be more resistant to tearing should the system inadvertently be turned on without said blade being freed from its frozen condition.

Said attaching protrusions incorporated in said connection housing incorporated in said adapted blade holder 35A are shown. Said optional flat metal rod 52 is shown in the position in which it would be located within said blade holder to wiper arm connecting means 10. In current embodiments said blade holder to wiper arm connecting means 10 would be compatible with wiper blade support arms currently in use. In future embodiments said wiper blade housing connecting means 10 could be adapted to the design illustrated in FIG. 19, to work with a newly designed wiper blade support arm created specifically for use with the currently disclosed blades, without changing the basic function of the currently disclosed blades.

Said V-blade 1 and said blade housing 2 could be constructed of a transparent silicone base material, which would interfere with driver visibility in a very minor way, if at all, or said V-blade 1 and said blade housing 2 could be made of rubber as blades currently in use are, but using the unique design parameters of the currently disclosed V-blade 1 and blade housing 2. Said blade holder 35 could be made of transparent polycarbonate material, metal, or hard plastic, also using the design parameters of said blade holder 35. This adaptation would follow the design parameters described herein, in order to retain the added effectiveness of performance of the unit, so therefore the material used would not alter the scope and spirit of the currently disclosed invention.

FIG. 5 is a cross section view of downsweep C-blade 7, an alternative embodiment of said upsweep C-blade 3. Said downsweep C-blade 7 is configured with two opposing C-curve sides 3A, each in the shape of a “C”, the bottom edges of each said C-curve side 3A being perpendicular to said windshield 58 when in use. Each of these said C-curve sides 3A is similar in shape to a snowplow blade, with a slightly raised area 3B on the bottom of said downsweep C-blade 7 between the lower ends of the said opposing C-curve sides 3A. This allows the lower points of said C-curve sides 3A to come into and remain in constant contact with said windshield 58, without having to flip over between forward and return strokes as conventional blades do. Said opposing C-curve sides 3A face in opposite directions, allowing one of said C-curve sides to move said water or snow off the windshield on the forward stroke, and the other of said C-curve sides to repeat this action on the return stroke. With a conventional blade said water or snow is simply pushed to one side by the stroke of the blade and left to collect either in the center of said windshield 58, or along the outer edge of said windshield 58. With the downsweep C-blade, the curvature allows said water or snow to be pushed up by the lower edge of each of said C-curve sides 3A, guided away from the wiping area by said downsweep C-blade 7. In this embodiment the upper section of said downsweep C-blade 7 is angled back toward said windshield 58 allowing said water or snow to be aimed back toward said windshield 58 at a considerable distance from the lower edge of said downsweep C-blade 7, rather than directly in front of it, making it easier for said downsweep C-blade 7 to push said water or snow away without it piling up as much in front of said downsweep C-blade 7 as it would with wiper blades currently in use, and thrown away from the central area of said windshield 58, and possibly off of said windshield 58 entirely, rather than being left lying in the area where said forward stroke or said return stroke ends, preventing said water or snow from being blown back into the line of vision of the driver as easily, and needing to be removed again by repeated use of the wiper system. This action also makes the use of cleaning fluid more effective, since it allows said solution to be dispersed more evenly, the firmness of said blade edge provides better cleaning action, and the construction of said blade allows said cleaning fluid and dirt to be removed from said windshield 58 quickly and completely rather than remaining on said windshield 58 to further interfere with the vision of the driver.

The central area of the downsweep C-blade 7, between the two said C-curve sides 3A is illustrated as being thick, to provide support to said C-curve sides 3A on both the forward and return strokes, but the thickness depicted in said illustration is not the only measure which would be possible. Any thickness which would produce the desired results would be acceptable. Said connecting shaft 8 and securing bar 9 of the unit, which connect said upsweep C-blade to said blade housing 2 are also much thicker than in conventional wiper blades. The thin shafts which are used to connect the blade to the housing in conventional systems, are much more prone to fail under the wear and tear of normal use than the thicker construction used in the current embodiment. Conventional blades are also subject to tearing at the point of connection to the housing because of the thinness of the shaft, should said blade become frozen to said windshield 58, and power be applied without first freeing said blade from said windshield 58. The thicker connecting shaft 8 and securing bar 9 incorporated in this embodiment of said downsweep C-blade 7 provides added strength and will be more resistant to tearing should said system inadvertently be turned on without said blade being freed from its frozen condition.

Said attaching protrusions incorporated in said connection housing incorporated in said adapted blade holder 35A are shown. Said optional flat metal rod 52 is shown in the position in which it would be located within said blade holder to wiper arm connecting means. In current embodiments said wiper blade housing connector 10 would be compatible with wiper blade support arms currently in use. In future embodiments said wiper blade housing connecting means 10 could be adapted to the design illustrated in FIG. 19, to work with a newly designed support arm created specifically for use with the currently disclosed blades without changing the basic function of said currently disclosed blades.

Said downsweep C-blade 7 and said blade housing 2 could be constructed of a transparent silicone base material, which would interfere with driver visibility in a very minor way, if at all, or it could be made of rubber as blades currently in use are, but using the unique design parameters of the disclosed downsweep C-blade 7 and blade housing 2. Said blade holder 35 could be made of transparent polycarbonate material, metal, or hard plastic, also using the design parameters of said blade holder 35. This adaptation would follow the design parameters described herein, in order to retain the added effectiveness of performance of the unit, so therefore the material used would not alter the spirit and scope of the invention.

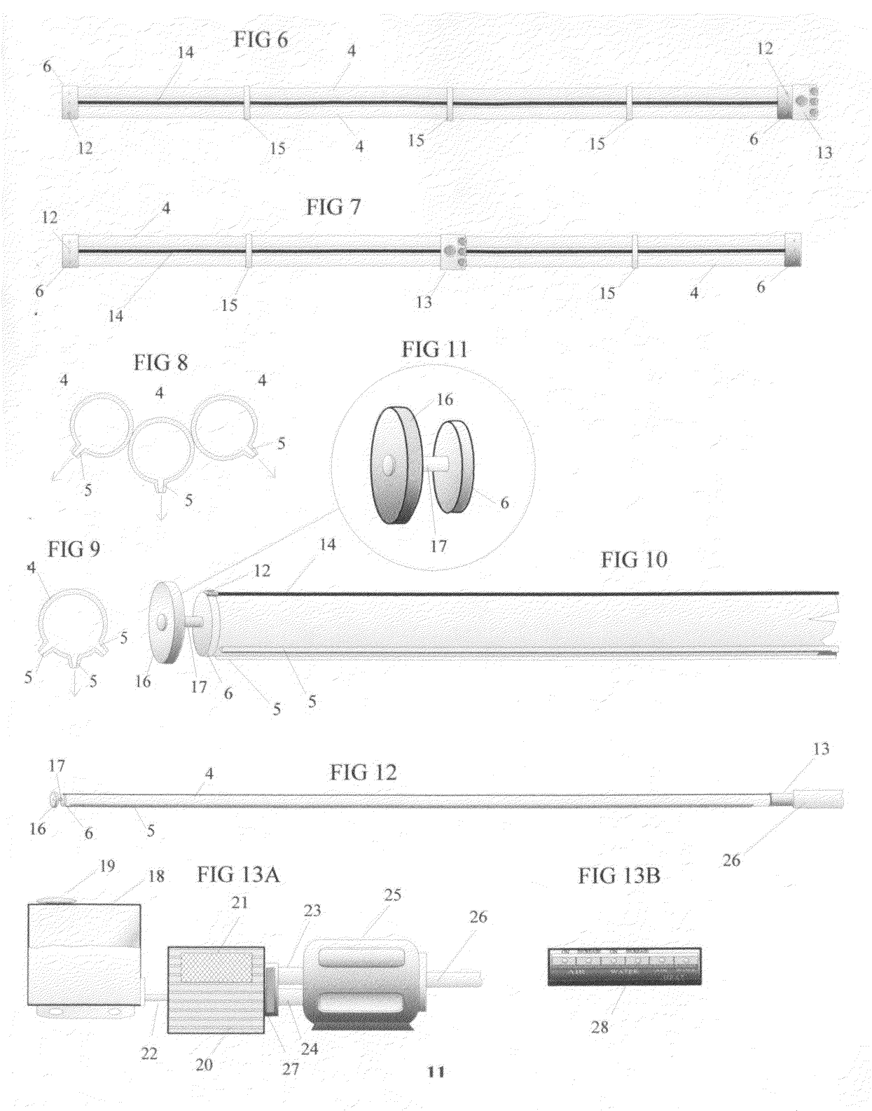

FIG. 6 illustrates a down view of an alternative embodiment of a windshield clearing and cleaning apparatus, which consists of a single water/air conducting tube 4, or plurality of such water/air conducting tubes 4, which take the place of either a traditional blade, or the V-blade 1, upsweep C-blade 3, or downsweep C-blade 7 shown in prior illustrations. Said water/air conducting tube 4 or plurality of water/air conducting tubes 4, constructed of a material such as molded plastic or clear plastic surgical tubing, serve to carry high pressure air or high pressure water to said windshield 58. This view of the embodiment shows that said water/air conducting tubes 4 are stabilized by a tube brace rod 14, which could be constructed of metal or strong plastic, and are held together in the case of a plurality of water/air conducting tubes 4, and attached to said tube brace rod 14 by means of a series of tube clamps 15. A water/air intake 13 is shown on the end of said plurality of water/air conducting tubes 4, which allows said high pressure water to be channeled from the water storage tank 18 in the case of high pressure water, coming into the system which is illustrated in its entirety in FIG. 13A, by way of water fill area 19, through the water storage tank to heater transfer tube 22, into the two chamber water/air heating unit 20, through warm water transfer tube 24, to an electric compressor pump 25, which feeds said high pressure water into high pressure water/air feed tube 26 which conducts said high pressure water to said water/air conducting tubes 4, to be dispensed onto said windshield 58 through small closely spaced water/air dispensing openings, which may be either holes or slots, in the undersides of said water/air conducting tubes 4, not visible in this illustration, which face toward said windshield 58. In the case of said high pressure air, the path would be slightly different, with said air entering through an air intake 21 into said two chamber water/air heating unit 20, traveling from there by way of warm air transfer tube 23 to a separate electric compressor pump 25, traveling from there through said high pressure water/air feed tube 26 to said water/air conducting tubes 4 to be dispensed onto said windshield 58 through said water/air dispensing openings 5. Said water/air dispensing openings 5 are located in a formation which incorporates one row of water/air dispensing openings 5 positioned to apply said high pressure air or high pressure water slightly ahead of the unit on the forward stroke, a second row of water/air dispensing openings 5 positioned to apply said high pressure air or high pressure water slightly ahead of said unit on the return stroke, and a third, central row of water/air dispensing openings 5 positioned to apply said high pressure air or high pressure water directly onto said windshield 58 at all times, allowing it to reinforce whichever of said rows of water/air dispensing openings 5 is in effect at the time. A control unit 27, illustrated in FIG. 13B, most probably located on the dashboard of said vehicle, determines by the positioning of an on/off mechanism, such as a button or switch, whether each element of said system, including said heating unit, or said pumps, are in operation, and whether water or air is being sent through said system. When in cleaning mode, said high pressure water, or windshield cleaning fluid if desired, is deposited on said windshield 58 on both the forward and return strokes. Said pressurized fluid removes dirt, insect residue and oily road film from said windshield 58, employing a similar principle to that used by a power washer, and pushing said used cleaning fluid and dirt completely off said windshield 58, with no need for scraping with a blade. A separate heating chamber for windshield washer fluid could also be incorporated into said system by using said two chamber water/air heating unit 20 so that heated water or cleaning fluid could be utilized if desired for more effective cleaning action. Said heated fluid could also be effective for melting ice on said windshield in winter. Said heated air could also possibly be used for this purpose. Each end of each of said water/air conducting tubes 4 is closed by a water/air conducting tube cap 6 incorporating a protrusion which fits snugly into the end of said water/air conducting tube 4, preventing said high pressure air or high pressure water from escaping through the end of said water/air conducting tube 4, and channeling all of said high pressure air or high pressure water available out through said water/air dispensing openings 5 in said water/air conducting tubes 4 and onto said windshield 58. Said water/air conducting tube cap 6 is held in place with one or more water/air conducting tube cap locking pins 12, passing through said water/air conducting tube cap 6 and through said water/air conducting tube 4. Said protrusions could also be glued in place inside said water/air conducting tube 4 if desired, for a more complete seal. Said water/air intake 13 located at the inner end of said plurality of water/air conducting tubes 4 also includes said blade holder to wiper arm connector 10 for attaching said unit to said wiper blade support arm which is attached to the left and right sweeping device at the lower edge of said windshield. Said high pressure water/air feeding tube 26 leading from said compressor/heater system into said plurality of water/air conducting tubes 4 is larger in diameter than said water/air conducting tubes 4, for the purpose of further concentrating the flow of said high pressure air or water when it enters said distribution system, increasing the pressure of said water or air even more, thus enabling it to function even more effectively.

FIG. 7 illustrates an alternate embodiment of the windshield clearing and cleaning apparatus disclosed in FIG. 6, constructed of molded plastic or clear plastic surgical tubing and incorporating said water/air intake 13 located in the center of said plurality of water/air conducting tubes 4, which allows said high pressure air or high pressure water to be channeled from said compressor/heater system illustrated in FIG. 13A, located under the hood of the vehicle. Said water/air intake 13, located at the center of said plurality of water/air conducting tubes 4, also includes said blade holder to wiper arm connector 10 for attaching said unit to said wiper blade support arm which is attached to the left and right sweeping device at the lower edge of said windshield 58. The high pressure water/air feed tube 26, leading from the compressor/heater system into said plurality of water/air conducting tubes 4 is larger in diameter than said water/air conducting tubes 4, for the purpose of further concentrating the flow of said high pressure air or water when it enters said distribution system, increasing the pressure of said water or air even more, thus enabling it to function even more effectively.

FIG. 8 illustrates an open end view of said plurality of water/air conducting tubes 4, constructed of molded plastic or clear plastic surgical tubing, to transport said high pressure water or high pressure air to be dispensed on said windshield 58 by means of said water/air dispensing openings 5 as shown by the arrows in the drawing. Placement of said water/air dispensing openings 5, which could be holes or slots, on the undersides of said water/air conducting tubes 4 is shown at the end of said water/air conducting tubes 4, with said water/air dispensing openings 5 continuing closely spaced along the entire effective length of said water/air conducting tubes 4, leaving only a connecting space at each extremity of said water/air conducting tubes 4 without water/air dispensing openings 5. The illustration shows an arrangement of three water/air conducting tubes 4, with each water/air conducting tube 4 containing a single series of water/air dispensing openings 5, which provides adequate overall coverage of the area of said windshield 58 to be cleared or cleaned, but a single water/air conducting tube 4, such as illustrated in FIG. 9, or any number of said water/air conducting tubes 4 which would effectively perform the needed function could be used.

FIG. 9 illustrates an open end view of an alternative embodiment of said water/air conducting tube 4 adaptation in which a single water/air conducting tube 4, constructed of a material such as molded plastic or clear plastic surgical tubing, is used to distribute high pressure air or high pressure water onto said windshield 58 by means of said water/air dispensing openings 5 as indicated by the arrows in the drawing. Instead of a single series of water/air dispensing openings 5, on said water/air conducting tube 4, as shown in FIG. 8, said single water/air conducting tube 4 is shown as having three series of said water/air dispensing openings 5 evenly spaced on the underside of said water/air conducting tube 4. Said water/air dispensing openings 5 are located in a formation which incorporates one row of said water/air dispensing openings 5 positioned to apply said high pressure air or high pressure water slightly ahead of said water/air conducting tube 4 on the forward stroke, a second row of said water/air dispensing openings 5 positioned to apply said high pressure air or high pressure water slightly ahead of said water/air conducting tube 4 on the return stroke, and a third, central row of said water/air dispensing openings 5 positioned to apply said high pressure air or high pressure water directly onto said windshield 58 at all times, allowing it to reinforce whichever of said rows of water/air dispensing openings 5 is having the most effect at the time. Placement of said water/air dispensing openings 5 on the undersides of said water/air conducting tube 4 is shown at the end of said water/air conducting tube 4, with said water/air dispensing openings 5, which could be holes or slots, continuing closely spaced along the entire effective length of said water/air conducting tube 4, leaving only a connecting space at each extremity of said water/air conducting tube 4 without said water/air dispensing openings 5.

FIG. 10 shows an illustration of a section of said water/air conducting tube 4, including said water/air conducting tube cap 6, which in this case is connected by a short metal or plastic support wheel connecting rod 17 to a rubber or plastic tube support wheel 16, just slightly larger in diameter than said water/air conducting tube cap 6, which is attached to said water/air conducting tube cap 6 by means of a water/air conducting tube cap locking pin 12 passing through said water/air conducting tube cap 6. Said tube support wheel 16 serves to hold said water/air conducting tube 6 in a slightly elevated position in relation to said windshield 58 so that said water/air conducting tube 4 is not in direct contact with said windshield, since this would block the flow of air or water through said water/air dispensing openings 5 in said water/air conducting tube or tubes 4. When said compressor/heater system is activated, the pressure of said high pressure air or high pressure water also assists in holding said unit away from said windshield 58 so that said high pressure air or water is free to contact said windshield 58 at full pressure for maximum effectiveness. A tube support wheel 16 is illustrated in the drawing, but instead of a wheel, said tube support could be a very small point made of hard plastic which would not scratch the glass of said windshield 58, but would serve the same purpose as said tube support wheel 16 of holding said water/air conducting tube 4 out of direct contact with said windshield 58, to facilitate effective distribution of said high pressure air or water. Depending upon placement of said water/air intake 13, said tube support wheel 16 (or tube support point) apparatuses may need to be located at both ends of said water/air conducting tube 4. This would especially be necessary when said water/air intake 13 is located in a central position on said water/air conducting tube or tubes 4, since both ends of said water conducting tubes 4 would be free to come into contact with said windshield if said tube support wheels 16 (or tube support points) were not applied. If said water/air intake 13 is located at the lower end of said water/air conducting tube 4 said water/air intake 13 will itself serve to hold said water/air conducting tube 4 away from said windshield. Said tube brace rod 14 is shown on the upper side of said water/air conducting tube 4. Said tube brace rod 14 may be secured to said water/air conducting tube 4 by a series of tube clamps 15 for added strength, or said tube brace rod 14 may be molded into said water/air conducting tube 4 itself.

Another option to insure that the wiper arm assembly holding said tube support wheels 16 incorporated into said water/air conducting tube 4 or plurality of water/air conducting tubes 4 maintain continuous contact with said windshield 58 is for a track system to be located at the top of said windshield 58 that is attached to the body of said vehicle just above said windshield 58. The track system can vary from an up and down semi-circular motion as conventional blades attached at the bottom edge of said windshield 58 use, to a horizontal sweeping back and forth motion, with an electric motor and a pulley system applied. In another adaptation a small curved track could be installed at the bottom of said windshield 58 to insure that said V-blade 1, upsweep C-blade 3 or downsweep C-blade 7 does not lose contact with said windshield 58, but retains contact during use of high pressure air or high pressure water. A third adaptation of the same principle would consist of a track system with a track at the top of said windshield 58 and a track at the bottom of said windshield 58, with a single V-blade 1, upsweep C-blade 3, downsweep C-blade 7, or water/air conducting tube 4 that goes back and forth across the full width of said windshield. All of these systems would operate with the use of an electric motor and a pulley system.

FIG. 11 is an isolated close up view of said water/air conducting tube cap 6 incorporating said tube support wheel 16. Said tube support wheel 16 is connected to said water/air conducting tube cap 6 by means of a short metal or plastic support wheel connecting rod 17. Said tube support wheel 16 is shown as being slightly larger in diameter than said water/air conducting tube cap 6, for the purpose of holding said water/air conducting tube 4 or plurality of water/air conducting tubes 4 a small distance away from said windshield to allow said high pressure water or air to be distributed evenly on said windshield.

FIG. 12 illustrates the complete water/air conducting tube assembly 4, including said water/air conducting tube cap 6, incorporating said tube support wheel 16 connected to the outer end of said water/air conducting tube assembly 4 by support wheel connecting rod 17. The inner end of said water/air conducting tube assembly 4 is shown attached to said high pressure water/air feed tube 26 which conducts said high pressure water or high pressure air from said compressor/heater system to said water/air conducting tube 4. Said high pressure water/air feed tube 16 is larger in diameter than said water/air conducting tube 4, serving to increase the pressure level of said air or water when it passes from said high pressure water/air feed tube 16 to said water/air conducting tube 4. Water/air dispensing openings 5 and tube brace rod 14 are also shown.

FIG. 13A is an illustration of the compressor/heater system located beneath the hood of said vehicle a wiper assembly incorporating said system. A water storage tank 18, with a water fill area 19 located in the upper surface of said water storage tank 18, is shown. Said water storage tank 18 is connected to a two chamber water/air heating unit 20 which can heat water or air. If desired there could be two separate heating units, one for air and one for water. In the current illustration the two are combined, with water being heated in one chamber, and air being heated in the other chamber. An air intake 21 is shown to allow air to enter the air heating chamber of said two chamber water/air heating unit 20. The heating coils which perform this operation can be activated by a control unit 28 located inside said vehicle as shown in FIG. 13B. A thermostat is incorporated into said two chamber water/air heating unit 20 to insure that the water and air that is being heated is warm enough to remove dirt and melt snow and ice from a frozen windshield 58, but not hot enough to crack said frozen windshield 58. A valve control shut off 27 which is also operated by said control unit 28 controls the flow of said air and water, so that either water or air can flow through the system and into said high pressure water/air feed tube 26, but not both at the same time. Separate outflow pipes, warm water transfer tube 24 and warm air transfer tube 23 are shown. From said two chamber water/air heating unit 20, said heated air or water next goes to an electric compressor pump 25, which controls air pressure and water pressure. After passing through said electric compressor pump 25, said heated air or water is sent through said high pressure water/air feed tube 26 through said water/air intake 13 to said water/air conducting tubes 4 to be dispensed through said water/air dispensing openings 5 onto said windshield 58.

FIG. 13B illustrates said control unit 28 which would be located inside said vehicle, probably but not necessarily on the dashboard. This control unit 28 would be used to activate and deactivate all functions of said compressor/heater system, including heating water, heating air, activating or deactivating said electric compressor pump 25 to send water or air through said high pressure water/air feed tube 26 to the dispensing tubes, and controlling whether it is air or water that is being processed. Said two chamber water/air heating unit 20, electric compressor pump 25, and control unit 28 are all run by electricity, drawn from the storage battery of the vehicle in which said compressor/heater system has been installed. Said control unit 28 could be connected to an adapter to be plugged into the cigarette lighter of the vehicle instead of being wired directly to the battery.

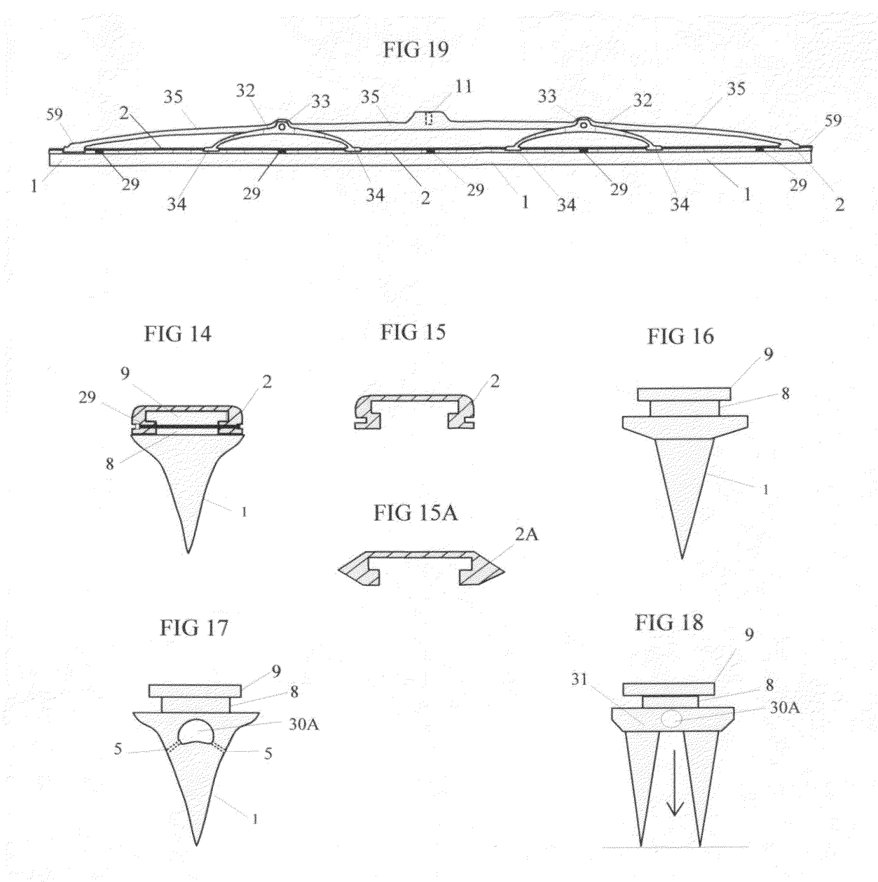

FIG. 14 illustrates a possible design for a blade housing 2 to hold the “V” blade embodiments, and the “C” blade embodiments illustrated in FIGS. 1, 2, 5 and 16-18, and also the high pressure air and high pressure water adaptations illustrated in FIGS. 3, 4, and 6-12. Said V-blade 1 is shown held inside said blade housing 2 by one of a plurality of wiper blade locking pins 29. Said wiper blade housing pins 29 are spaced evenly along the entire length of said wiper blade housing 2. Said blade housing 2 and said wiper blade locking pins 29 are also suitable for use with said “C” blade embodiments illustrated in FIGS. 2 and 5.

FIG. 15 illustrates an end view of said blade housing 2 as it would appear alone, without said V-blade 1, said upsweep C-blade 3 or said downsweep C-blade 7 secured within said blade housing 2.

FIG. 15A illustrates an end view of said adapted blade housing 2A designed specifically for said upsweep C-blade, as it would appear alone, without said upsweep C-blade secured within said adapted blade housing 2A.

FIG. 16 illustrates an end view of said V-blade 1 separate from said blade housing 2. Said V-blade 1 is shown as being slightly more narrow in the lower portion of said blade than the view shown in FIG. 1, and widening out at an angle at the upper end to assist in moving water or snow off said windshield 58. This change in thickness would not alter the basic function of said V-blade 1, and therefore would not fall outside the spirit and scope of the currently disclosed invention.

FIG. 17 illustrates an alternative embodiment of said V-blade 1 designated as the channel blade 30, which performs a similar function to the embodiments illustrated in FIGS. 3 and 4, but without the addition of external water/air conducting tubes 4 as shown in these drawings. Instead, a water/air conducting channel 30A is molded into the center of said channel blade 30 itself, with small evenly spaced water/air dispensing openings 5 molded or pierced into the side angles of said channel blade 30. A slight upraised indentation on the bottom of said water/air conducting channel 30A, which makes said water/air conducting channel 30A stronger and channels the flow of high pressure water or air more completely and evenly onto said windshield 58 to insure better clearing and cleaning action This shaping is not the only adaptation available, as other shapes, such as circular, square, triangular or any shape which would allow the channel blade 30 to fulfill the intended function could be used. This embodiment would save on material cost, since said external water/air conducting tubes would not be needed and said channel blade 30 would also use less material because of said water/air conducting channel 30A. This embodiment would also do away with the need for an additional specially adapted blade housing to accommodate for the presence of external water/air conducting tubes 4

FIG. 18 illustrates a divided blade 31, molded in one piece upon a single upper shaft. Since conventional dual blades are molded individually on separate upper shafts this adaptation would make said divided blade more stable than dual blades which are molded separately and clamped within the same housing, would save on material cost for said blade itself, and would not require a special wiper blade holder 35 to hold the divided blade, but would allow the same wiper blade holder 35 to be used as is used for other embodiments of the currently disclosed V-blade 1. This unit would also take up less space on said windshield 58 then conventional double blade units, thereby causing less interference with driver visibility. If desired a water/air dispensing channel 30A could by located in the central area of said divided blade 31, allowing water or air to be dispensed onto said windshield 58 from between the sections of said divided blade 31 as shown by the arrow in the drawing.

FIG. 19 illustrates an alternative embodiment of a newly designed wiper blade holder 35 which incorporates an improved design which will reduce weight and use less material, while at the same time increasing the strength of said wiper blade holder 35 and allowing it to hold the clearing edge of said blade in closer and more constant contact with said windshield. The adapted wiper blade holder 35 could if necessary be specifically constructed to receive the blade housing 2 and adapted blade housing 2A designed for the V-blade embodiments and C-blade embodiments disclosed in the current invention. Rather than using clips at each end of the housing, as wiper blade housings currently in use do, said blade housing 2 and adapted blade housing 2A could use a series of evenly spaced wiper blade locking pins 29 along the length of said blade and housing, holding said blade more securely in place within said blade housing 2 or said adapted blade housing 2A along its entire length. The illustration shows five wiper blade locking pins 29, but fewer or more could be used as long as said V-blade embodiments or said C-blade embodiments are sufficiently secure inside said blade housing 2 or adapted blade housing 2A. Two additional support structures 32, one spaced evenly between the center of said wiper blade holder 35 and the outer end of said wiper blade holder 35, and one spaced evenly between the center of said wiper blade holder 35 and the inner end of said wiper blade holder 35, attached to the upper bar of said wiper blade holder 35 with support structure connecting pins 33 and fastened to said blade housing 2 with support structure connecting clips 34 located at each end of each support structure 32, serve to further stabilize said wiper blade embodiments and keep them in closer contact with said windshield. Said blade holder 35 is attached to said blade housing by blade holder clips 59. Wiper blade holder connection opening 11 which could be adapted to accept wiper arm connections currently in use is also shown.

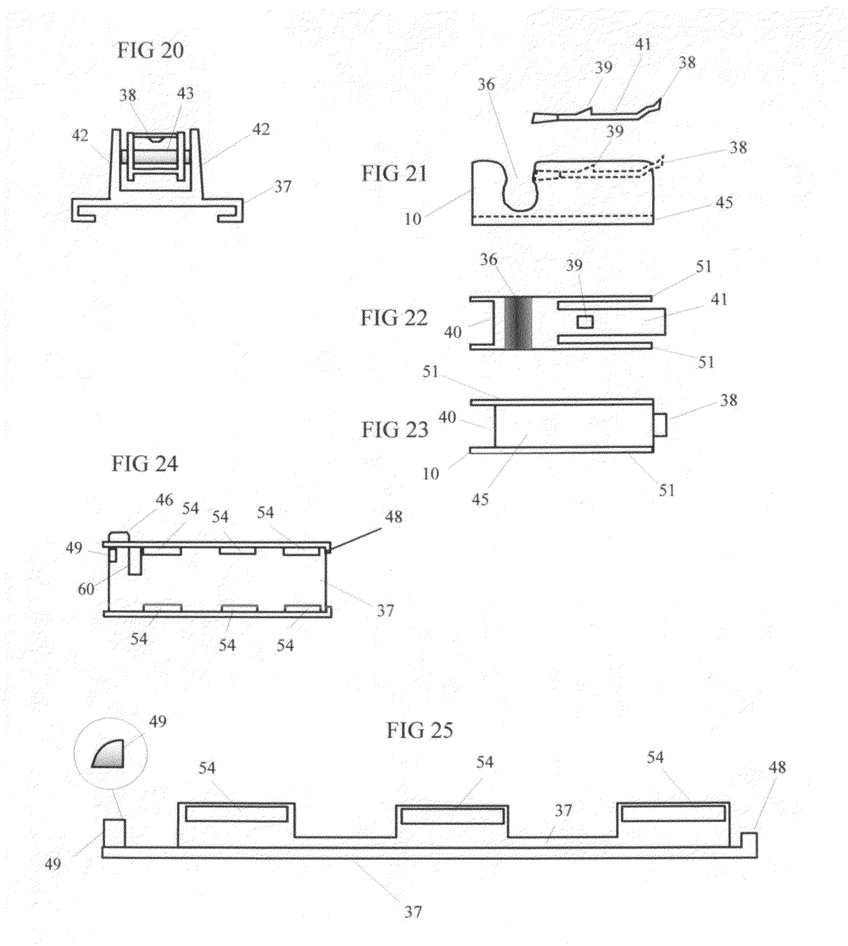

FIG. 20 illustrates an end view of a blade holder to wiper arm connecting means 10, incorporating pressure clip 41, support walls 42, securing rod 43 and pressure clip holder 38. Said wiper arm connecting clip slides into said inserting space 36 incorporated into said pressure clip 41, which is shown in FIG. 21, and locks in place, holding said wiper blade securely on the wiper support arm while the wiper system is in use. Said blade holder to wiper arm connecting means 10 is compatible with wiper arms currently in use, allowing the blade embodiments of the currently disclosed invention to be used with said current wiper arms.

FIG. 21 illustrates an exploded side view of said blade holder to wiper arm connecting means 10. The body of said blade holder to wiper arm connecting means 10 incorporates said inserting space 36 to receive the connecting clip of said wiper support arm connected to said vehicle. A pressure clip 41 incorporating said securing protrusion 39 and said pressure clip holder 38 is shown in a separate view, with the location of said pressure clip 41 within the body of said attaching means 37 indicated by dotted lines. A securing protrusion 39 is incorporated into said pressure clip 41 which connects said attaching means to said wiper arm. Bottom pressure clip panel 45, is also indicated by dotted lines.

FIG. 22 illustrates a down view of said pressure clip 41. Said inserting space 36 is indicated on the upper surface of said pressure clip 41 to receive the connecting clip of said wiper support arm. Said side walls 51 are shown, as is clip securing device 41 incorporating said securing protrusion 39 which allows said pressure clip to secure said wiper arm to said blade holder

FIG. 23 Illustrates an underneath view of said blade holder to wiper arm connecting means 10. The bottom surface of said blade holder to wiper arm connecting means 10 and said side walls 51 are shown, as is the outer end of said pressure clip 38, as it would appear when said pressure clip 38 is inserted within said pressure clip insertion area 44.

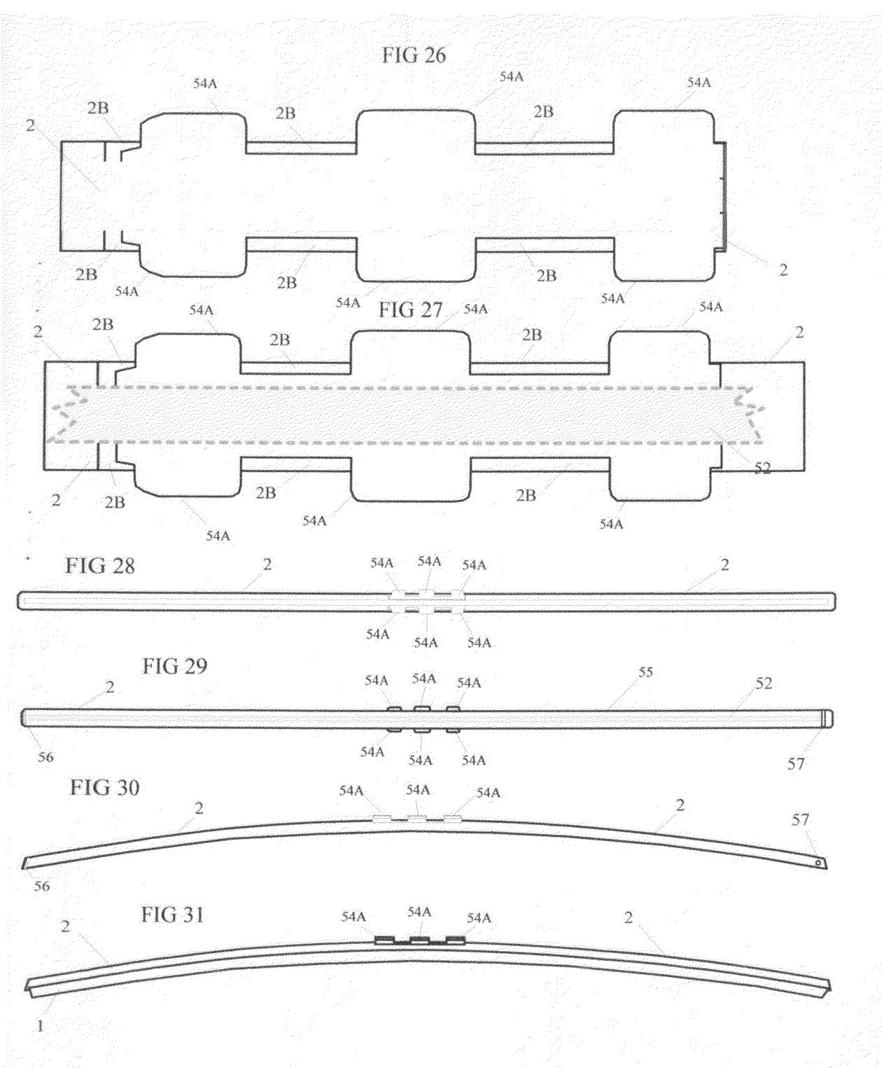

FIG. 24 illustrates an under view of the attaching means 37 which is incorporated on the underside of said blade holder to wiper arm connecting means 10. Locking projections 47 are incorporated into the inside surfaces of the outer sides of said attaching means 37, by means of which said blade holder to wiper arm connecting means 10 is secured to a connector housing 50 molded into said blade holder 35. When said attaching projections 54A are united with connecting protrusions 54 incorporated into said connector housing 50, which are illustrated in FIGS. 26-31, by inserting said blade holder to wiper arm connecting means 10 into said blade holder 35, lock release 49 is pushed down thus allowing said securing projections 39 to slide underneath said locking projections 47, at which time said lock release 49 returns to its normal position, locking said blade holder to wiper arm connecting means 10 in place. When it is necessary to remove said blade holder to wiper arm connecting means 10 from said attaching means 37, it is necessary to pull upward on said locking means 46 and slide said attaching means 37 in the opposite direction to remove said blade holder to wiper arm connecting means 10 from said connector housing 50 Attaching means stoppers 48, are also shown, whereby when coupling said connector housing 50 to said blade holder to wiper arm connecting means 10 said attaching means stoppers 48 halt forward motion of said blade holder to wiper arm connecting means 10 at the proper position for said locking means 46 to be activated. Connection indentations 2B allows connecting protrusions 54 to slide under attaching protrusions 54A connecting said blade holder to wiper arm connecting means 10 to become attached to said connecting housing.

FIG. 25 illustrates a lengthwise cutaway view of said attaching means 37 Said connecting protrusions 54 are shown extending into the center of said attaching means 37, in a slightly elevated position to allow said attaching protrusions 54A incorporated into said attaching means 37 located on the underside of said blade holder to wiper arm connecting means 10 to slide into said connection indentations 2B and slide forward allowing said attaching protrusions 54 to slide beneath said connecting protrusions 54A to hold said blade holder to wiper arm connecting means 10 in place upon said connector housing 50, allowing said wiper unit to carry out its designed function. An attaching means stopper 48 is shown which holds said blade holder to wiper arm connecting means 10 securely in place once it has been inserted into said connector housing 50. A lock release 49 is shown in position within said attaching means 37 and again in a separate view above to illustrate the shaping of said lock release 49 on the side which is not visible in the current illustration. A lock enabling opening 60 is shown which allows said lock release 49 to move with a springboard-like motion allowing said lock release to function.

FIG. 26 illustrates a down view of said connector housing 50 which is molded into said adapted blade holder 2A, with said attaching protrusions 54A incorporated into said connector housing 50 shown, which lock with said connecting protrusions 54 incorporated into said attaching means 37. Said connector housing 50 is located in a central space 53 in said blade holder 35. Connection indentation 2B allows connecting protrusions 54 to slide under attaching protrusions 54A connecting said blade holder to wiper arm connecting means 10 to become attached to said connector housing 50.

FIG. 27 illustrates a down view of the same connector housing 50 depicted in FIG. 26, with the addition of said optional flat metal rod 52, which would most probably be positioned within a slot between said connector housing 50 and said blade housing 2. Said optional flat metal rod 52 would be slightly bent at the center, creating a slight curve in said wiper blade which would serve to keep said wiper blade in close and constant contact with said windshield 58. The location of said optional flat metal rod 52 in a slot between said blade housing 2, and said connector housing 50 is shown by dotted lines, as it would not normally be visible in this view. Connection indentation 2B allows connecting protrusions 54 to slide under attaching protrusions 54A connecting said blade holder to wiper arm connecting means 10 to become attached to said connecting housing.

FIG. 28 illustrates a down view of said blade housing 2 with said connector housing 50 located within central space 53. Said attaching protrusions 54A are shown on said connector housing 50, and said optional flat metal rod 52 is also shown in central space 53.

FIG. 29 illustrates an underneath view of said blade housing 2, showing said optional flat metal rod 52 positioned inside a groove holder 55 which keeps said flat metal rod 52 firmly anchored so the curved area in the center of said flat metal rod 52 will remain in the same place, not allowing the curvature of said blade to change, since it is this curvature which is helping said blade to remain in contact with said windshield 58. A blade stopper wall 56 is shown at the outer end of said blade housing 2 to keep the end of said blade from going past the end of said blade housing 2 and not remaining in said holder, This is aided by a blade holding pin 57 located on the inner end of said wiper blade. Said blade holding pin 57 penetrates said blade housing 2 and said wiper blade, which could be any of the V-blade or C-blade embodiments, insuring that said blade is held securely and will not come out of said blade holder 2. Connection indentation 2B allows connecting protrusions 54 to slide under attaching protrusions 54A connecting said blade holder to wiper arm connecting means 10 to become attached to said connecting housing.

FIG. 30 illustrates a side view of said blade housing 2, not attached to a wiper blade. Said attaching protrusions 54A incorporated into said connector housing 50 are shown located in said central space 53 of said blade holder 35. Said blade stopper wall 56 and said blade holding pin 57 are also shown. Connection indentation 2B allows connecting protrusions 54 to slide under attaching protrusions 54A connecting said blade holder to wiper arm connecting means 10 to become attached to said connecting housing.

FIG. 31 illustrates a side view of said blade housing 2 attached to a wiper blade. Said attaching protrusions 54A incorporated into said connector housing 50 are shown located in said central space 53 of said blade holder 35. Connection indentation 34B allows connecting protrusions 54 to slide under attaching protrusions 54A connecting said blade holder to wiper arm connecting means 10 to become attached to said connecting housing.

FIGS. 20-25 illustrate a variation of the blade holder to wiper arm connection in use today, and are not being claimed as part of the invention. They are shown for the purpose of clarifying those parts of the wiper blade holder which attach to the wiper arm connection.

The components of the compressor/heater system are not limited to specific devices. Any devices which would accomplish the functions needed would be acceptable and would not alter the scope of the invention.

I claim:

1. A windshield cleaning and clearing device which incorporates a plurality of blade designs which share the common features of additional thickness of the blade itself and of the connecting shaft and securing bar which anchor said blades into an adapted housing, for additional strength and stability and improved performance, including:
a. a v-shaped blade which cleans and clears a windshield using a squeegee effect for more complete cleaning and clearing because said v-shaped blade is stronger and does not flip over between forward and reverse strokes;
b. a v-shaped blade which incorporates one or a plurality of water/air conducting tubes containing water/air dispensing openings attached to the outer edges of aid blade to dispense water or air onto said windshield to remove rain, snow, or dirt more efficiently;
c. a v-shaped blade which incorporates a water/air conducting channel within the blade itself, with dispensing openings in the sides of the blade to dispense water or air onto the windshield to remove rain, snow or dirt more efficiently;
d. a double v-shaped blade with both blade sections molded onto a single upper shaft for added strength and improved performance;
e. a back-to-back c-shaped blade with upsweep c-curve sides to clear rain, snow, or dirt from a windshield by throwing said rain, snow, or dirt to the edge of the windshield and possibly off the windshield altogether;
f. a back-to-back c-shaped blade with downsweep curved sides to clear rain, snow, or dirt farther ahead of said blade than would be possible with conventional blades, preventing said rain, snow, or dirt from piling up ahead of said blade and being left within the viewing area of the driver and blocking vision through the windshield.

2. The adapted wiper blade housing of claim 1, designed with extra width to accommodate the wider connecting shaft and support bar of blade designs of claim 1, said housing to be attached to said blade by a plurality of wiper blade locking pins.

3. A windshield cleaning and clearing device which does not use blades, but rather uses one or a plurality of water/air conducting tubes molded together or held together held together by tube clamps and supported by a tube brace rod, said water/air conducting tubes incorporating water/air dispensing openings to dispense high pressure air or water onto a windshield for the purpose of cleaning or clearing said windshield of rain, snow, or dirt.

4. The windshield cleaning and clearing device of claim 3 wherein said water/air conducting tubes have tube caps also incorporating tube support wheels or points, slightly larger than said tube caps, attached by a support connecting rod, said tube caps closing the ends of said water/air conducting tubes, preventing high pressure air or water within said tubes from escaping, but channeling it onto said windshield through said water/air dispensing openings, while said tube support wheels prevent said water/air conducting tubes from coming into contact with the windshield which would cause interference with the flow of said water or air onto said windshield, inhibiting the cleaning and clearing process.

5. A heating/compressor system connected to the windshield cleaning and clearing device of claim 3, to allow water and/or air to be heated and pressurized and sent to said water/air conducting tubes heated and under pressure, said heating/compressor system comprised of a water storage tank including a water fill area, a two chamber water/air heating unit with an incorporated air intake said water advancing from said water storage tank to said two chamber water/air heating unit by a water storage tank to heater transfer tube, with said heated water or heated air advancing to one or a plurality of electric compressor pumps by means of a warm air transfer tube and a warm water transfer tube, to be pressurized before being released into a high pressure water/air feed tube to be conducted through a water/air intake into said water/air conducting tubes or water/air conducting channel to be dispensed onto said windshield.

6. A wiper blade holder designed for use with the blade embodiments of claim 1 comprising a central opening with a connector housing molded into it to be attached to a wiper arm connection by means of connecting protrusions incorporated into said connection housing, support structures incorporated into said blade holder, held by support structure connecting pins on the upper level of said wiper blade holder and support structure connecting clips attached to the lower level of said wiper blade holder, and said wiper blade holder being attached to said blade housing by wiper arm clips.
